(19) United States
(12) Patent Application Publication
(10) Pub. No.: US 2010/0325099 A1
(43) Pub. Date: Dec. 23, 2010

(54) User friendly notification system for favorable or desired sea conditions

(76) Inventor: Anthony Shad Cundiff, Santa Fe, TX (US)

Correspondence Address: Anthony Shad Cundiff, P.O. Box 987, Santa Fe, TX, 77517, US

(21) Appl. No.: 12/803,174

(22) Filed: Jun. 19, 2010

Related U.S. Application Data
(60) Provisional application No. 61/269,233, filed on Jun. 22, 2009.

(51) Int. Cl. G06F 17/30

(52) U.S. Cl. 707/705; 707/803; 707/812; 707/E17.005; 707/E17.009

(57) ABSTRACT

A process, which provides for retrieving, computing, and storing available sea state condition data and user selected parameters notifies the user when his or her parameters are met. This embodiment computes forecasted sea state condition values to derive forecasted averages, and compares those averages to user selected thresholds for the selected locations. This embodiment proactively notifies users when desired sea state conditions will be met thus providing a more effective and safe way to plan on the water activities.

### CROSS-REFERENCE TO RELATED APPLICATIONS

This application claims the benefit of PPA Ser. No. 61,269,233 filed May 22, 2009 by the present inventor, which is incorporated by reference.”

### SEQUENCE LISTING OR PROGRAM

Attached is a CDROM which includes complete source code in ASCII format.

### BACKGROUND

Most offshore fishing or boating enthusiasts go out on the water when weather and surface conditions are acceptable to them. If the seas are too rough in their opinion for their vessel, then they do not go out. When they believe the seas are within what they consider to be calm or tolerable, they will go out on the water to their desired location.

Buoys, located in the oceans and other large bodies of water report the current conditions of their location. Boating enthusiasts and other people who spend time on the water will check this information in hopes they will find the conditions they are looking for. Quite often sea goers will experience the frustration of frequently checking conditions when they are unfavorable, only to later discover they missed an opportunity to go out on the calm day that they failed to check conditions.

As an avid angler, I have spent countless hours on the internet, or on the phone, checking and re-checking the “buoy reports” to see what the wave height and weather conditions will be like for our groups' next offshore or near shore fishing trip. I have also missed several “Flat” days because I hadn't checked the reports often enough. I first thought of this idea and created this embodiment on Wednesday, May 20, 2009, out of frustration, necessity, and the love of being on the water.

An embodiment which I have created will send notification to a user of water conditions which meet parameters he or she has selected for a given location, date, and time. This will save the user much time and energy that would have been spent checking on conditions that are unfavorable and searching through information that is useless to a user. This will give a user more opportunities to be aware of favorable conditions; and reduce the amount of lost opportunity on favorable conditions that were overlooked or not checked.

### SUMMARY

This embodiment gives the user a forecasted indication of when favorable conditions are met on the oceans or lakes, and greatly reduces wasted time and wasted opportunity. The user enters sea condition parameters he or she wishes to be notified of for a chosen location into this embodiment, and this embodiment sends data to the user when those thresholds are met at that location.

### DRAWINGS

FIG. 1 is a flowchart of the method of the embodiment.

### DETAILED DESCRIPTION

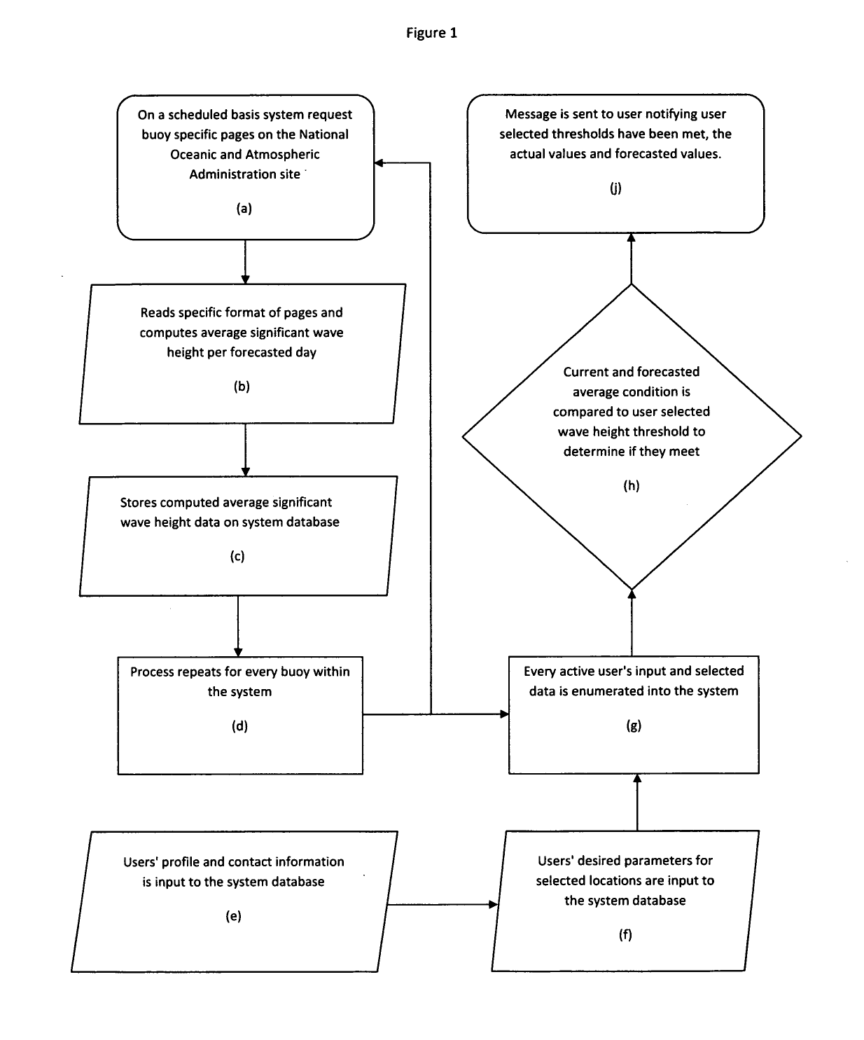

Description—FIG. 1

This embodiment is written in Microsoft's C# language, using the .NET Framework v3.5 SP1 and the ASP.NET MVC 2 Framework. The database is Microsoft SQL Server 2008 and the web server is Microsoft Windows Server 2008 IIS 7.0.

This embodiment is a web application; any computer that can process HTML/JavaScript data can be used. This system may be used on Windows, Linux, Mac OSX, and mobile phones that are internet capable. A user needs a computer with a user interface that has an internet connection.

This embodiment is comprised of programming which on a scheduled basis request buoy specific pages from the National Oceanic and Atmospheric Administration (NOAA) website (1a). Next this method pulls down those pages and reads them in their specific format (fixed field ASCII text file), computes the average significant wave height per forecasted day in the file (1b) and then stores that information in this embodiment's own database (1c). This process is repeated for every buoy within this embodiment's system (d).

Users input profile and contact information into the system database (1e). Users input selected wave height thresholds for desired locations to the system database (1f). When the average significant wave height per forecasted day is computed and stored within the database for the buoys within the system, every active user is enumerated in the system (1g). Their selected wave height threshold is compared to the forecasted average (1h) for the locations and times the user specified. If their threshold is met, the embodiment will send data to the user (1j). The user will receive information from this system (1j), via an email account and or a SMS capable phone or device (1j).

Operation—FIG. 1

This software is used to run the website application, which consists of: the static site serving up images, text, video clips, and Flash/Shockwave animation (1a).

Scheduled processes run every 24 hours (1d).

These processes programmatically pull down web pages from the NOAA site (1a), process their text, manipulate the data to find average present conditions and forecasted conditions (1b), and then store data in the system database (1c).

This process involves reading the pages specific ASCII text file format, computing the average significant wave height per forecasted day, and then storing the information in the system database. This process is repeated for every buoy within this system (1d).

Once the forecasted average is computed, every active user's selections are queried against the actual and forecasted data (1h).

If the actual and/or forecasted parameters for a selected location meet the parameters the user has selected, then the system sends a notification to the user (1j).

The user will receive the actual conditions and forecast conditions from this system (1j), via an email account and or a SMS capable phone or device (1j).

### CONCLUSION, RAMIFICATION, AND SCOPE

This embodiment is a process, which provides for computing forecasted sea state condition data retrieved from web pages. This embodiment computes and stores averages on scheduled intervals. This embodiment stores users' entered parameters for desired sea state conditions and proactively notifies users when thresholds have been met for a selected location.

While my above description contains many specificities, these should not be construed as limitations on the scope, but rather as an exemplification of one preferred embodiment thereof. Many other variations are possible. For example I presently contemplate for this embodiment to collect current and forecasted sea conditions from buoy data from the National Oceanic and Atmospheric Administration buoys. However, an alternative embodiment could collect data from other sources such as but not limited to computer modeling, satellite communication, radar, or ultrasonic sensor. I presently contemplate for this embodiment to notify the user of conditions met by SMS, or e-mail. However, alternative embodiments could effectively communicate with the user by any device capable of receiving a data signal and communicating with a user interface.

Thus the reader will see that at least one embodiment of the User Friendly Notification System for Favorable or Desired Sea Conditions provides an easy way for water enthusiast to more safely and effectively save time and effort when planning their boating activities.

1. A method for sending a user data when computed average sea states at locations of interest are within user selected parameters, comprising the steps of:
a. retrieving forecasted condition data
b. computing forecasted condition data to derive averages on scheduled intervals
e. providing a data input means which a human operator can use to store desired sea state parameters for desired locations
c. providing a memory which will store computed data
d. repeating data retrieval, computation, and data storage to said memory
f. creating a database of forecasted averages and user selected parameters
g. providing a memory controller which will be able to compare the stored forecasted averages to the user selected parameters for selected locations
h. sending information to user when user selected parameters and forecasted conditions for the same location are satisfied

2. The embodiment in claim one includes a method for computing averages from data collected from web pages

3. The embodiment in claim 1 includes a method for comparing user selected parameters to computed data from web pages whereby a user can easily receive notification when the parameters he or she has entered into this embodiment are met by forecasted average sea states for the location the user has pre-selected.
